(19) United States
(12) Patent Application Publication
(10) Pub. No.: US 2009/0322701 A1
(43) Pub. Date: Dec. 31, 2009

(54) METHOD AND APPARATUS FOR DETECTING TWO SIMULTANEOUS TOUCHES AND GESTURES ON A RESISTIVE TOUCHSCREEN

(75) Inventors: HENRY M. D'SOUZA, SAN DIEGO, CA (US); RaeAnne L. Dietz, SAN FRANCISCO, CA (US)

Correspondence Address: MARGUERITE E. GERSTNER;TYCO ELECTRONICS CORPORATION, INTELLECTUAL PROPERTY LAW DEPARTMENT, 309 CONSTITUTION DRIVE M/S R34/2A, MENLO PARK, CA, 94025-1164, US

(73) Assignee: TYCO ELECTRONICS CORPORATION, BERWYN, PA (US)

(21) Appl. No.: 12/165,306

(22) Filed: Jun. 30, 2008

(51) Int. Cl. G06F 3/041

(52) U.S. Cl. 345/174

(57) ABSTRACT

Resistive touchscreen system has a substrate with a first conductive coating having a first resistance and a coversheet with a second conductive coating having a second resistance. The substrate and coversheet are positioned proximate each other such that the first conductive coating faces the second conductive coating. The substrate and coversheet are electrically disconnected with respect to each other in the absence of a touch. First and second sets of electrodes for establishing voltage gradients in first and second directions are formed on the substrate and the coversheet, respectively. A controller biases the first and second sets of electrodes in two different cycles. The controller senses a bias current associated with at least one of the first and second resistances. The bias current has a reference value associated with no touch. An increase in the bias current relative to the reference value indicates two simultaneous touches.

### BACKGROUND OF THE INVENTION

This invention relates generally to touchscreen systems and more particularly to resistive touchscreen systems.

Resistive touchscreens are used for many applications, including small hand-held applications such as mobile phones and personal digital assistants. Unfortunately, when a user touches the resistive touchscreen with two fingers simultaneously, creating two touches or dual touch, the specific locations of two touches cannot be determined. Instead, the system reports a single point somewhere on the line segment between the two touches as the selected point, which is misleading if the touch system cannot reliably distinguish between single-touch and multiple-touch states.

However, the detection and use of two simultaneous touches is desirable. A user may wish to interact with data being displayed, such as graphics and photos, or with programs such as when playing music. The ability to use two simultaneous touches would increase the interactive capability the user has with the resistive touchscreen system.

Therefore, a need exists for the detection of two simultaneous touches on a resistive touchscreen.

### BRIEF DESCRIPTION OF THE INVENTION

In one embodiment, a resistive touchscreen system comprises a substrate having a first conductive coating that has a first resistance and a coversheet having a second conductive coating that has a second resistance. The substrate and coversheet are positioned proximate each other such that the first conductive coating faces the second conductive coating. The substrate and coversheet are electrically disconnected with respect to each other in the absence of a touch. A first set of electrodes for establishing voltage gradients in a first direction are formed on the substrate and a second set of electrodes for establishing voltage gradients in a second direction are formed on the coversheet. A controller is configured to bias the first and second sets of electrodes in two different cycles. The controller senses a bias current associated with at least one of the first resistance and the second resistance. The bias current has a reference value associated with no touch. An increase in the bias current relative to the reference value indicates two simultaneous touches.

In another embodiment, a method for detecting two simultaneous touches on a resistive touchscreen system comprises biasing a resistive touchscreen to generate voltage gradients along a first direction and a second direction. A first bias current associated with the first direction is detected. The first bias current is associated with a non-zero first reference value that is representative of a bias current along the first direction when no touch is present on the resistive touchscreen. A second bias current associated with the second direction is detected. The second bias current is associated with a non-zero second reference value that is representative of a bias current along the second direction when no touch is present on the resistive touchscreen. Two simultaneous touches are determined to be present on the resistive touchscreen when one of the first and second bias currents is greater than the first and second reference values, respectively.

### BRIEF DESCRIPTION OF THE DRAWINGS

FIG. 1 illustrates a 4-wire resistive touchscreen system formed in accordance with an embodiment of the present invention.

FIG. 2 illustrates a circuit representative of resistance within a touchscreen system in accordance with an embodiment of the present invention.

FIG. 3 illustrates the resistive touchscreen system of FIG. 1 that senses the bias currents in a cycle separate from the coordinate detection cycles in accordance with an embodiment of the present invention.

FIG. 4 illustrates the resistive touchscreen system of FIG. 1 that senses the bias currents in accordance with an embodiment of the present invention.

FIG. 5 illustrates a conceptual circuit diagram of a current measuring circuit as may be implemented on an ASIC in accordance with an embodiment of the present invention.

FIG. 6 illustrates a method for determining if two touches are present and for identifying the initial coordinates of the two touches in accordance with an embodiment of the present invention.

FIG. 7 illustrates a method for identifying gestures that use two touches in accordance with an embodiment of the present invention.

FIG. 8 illustrates two touches on a resistive touchscreen that are moving away from each other in accordance with an embodiment of the present invention.

FIG. 9 illustrates two touches on a resistive touchscreen that are moving towards each other in accordance with an embodiment of the present invention.

FIG. 10 illustrates a method for identifying rotate gestures that uses two touches in accordance with an embodiment of the present invention.

FIG. 11 illustrates a set of quadrants for determining a direction of rotation in accordance with an embodiment of the present invention.

FIG. 12 illustrates example signal profiles or traces corresponding to bias currents associated with different gestures in accordance with an embodiment of the present invention.

FIG. 13 illustrates a substrate that may be used in a 3-wire, 5-wire, 7-wire or 9-wire touchscreen in accordance with an embodiment of the present invention.

### DETAILED DESCRIPTION OF THE INVENTION

The foregoing summary, as well as the following detailed description of certain embodiments of the present invention, will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (e.g., processors or memories) may be implemented in a single piece of hardware (e.g., a general purpose signal processor or random access memory, hard disk, or the like). Similarly, the programs may be stand alone programs, may be incorporated as subroutines in an operating system, may be functions in an installed software package, and the like. It should be understood that the various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

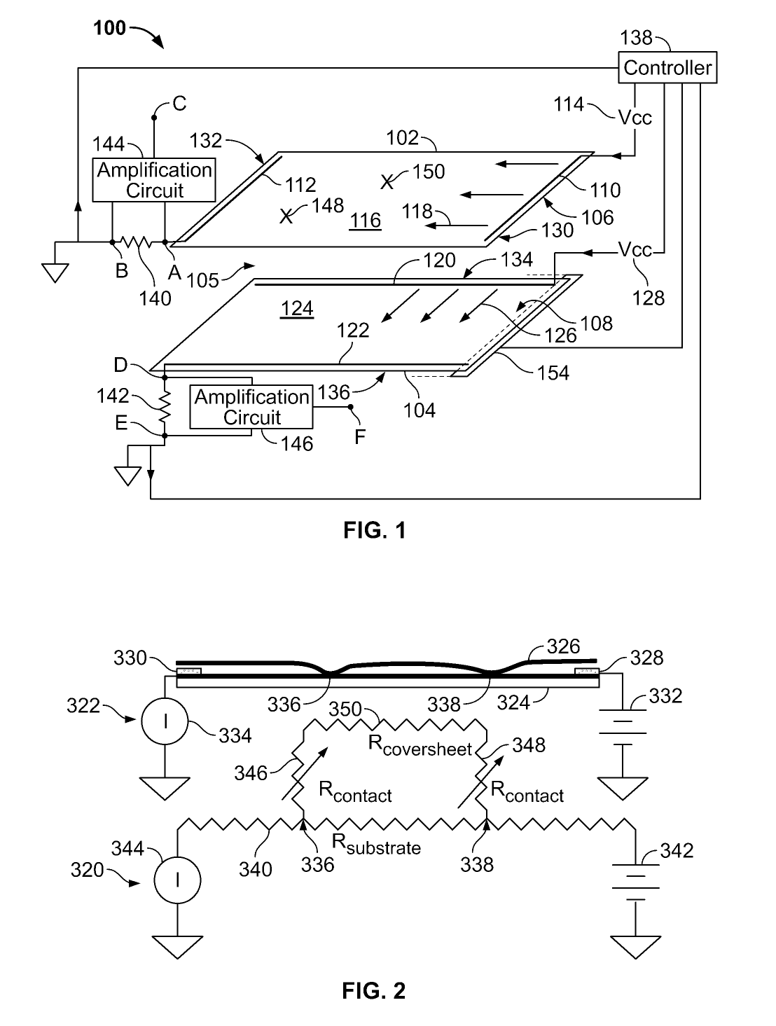

FIG. 1 illustrates a 4-wire resistive touchscreen system 100. The touchscreen of the touchscreen system 100 has a coversheet 102 that is placed over a substrate 104 with a narrow air gap in between. The coversheet 102 may be a polymer film such as polyethylene terephthalate (PET) and the substrate 104 may be formed of glass. Other materials may be used. In the absence of a touch, spacers (not shown) prevent contact between the coversheet 102 and substrate 104.

First and second conductive coatings 106 and 108 are formed on the two surfaces of the coversheet 102 and substrate 104, respectively, facing the air gap. The first and second conductive coatings 106 and 108 may be transparent and may be formed of materials such as indium tin oxide (ITO), transparent metal film, carbon nanotube containing film, conductive polymer, or other conductive material. At right and left sides (or opposite sides) 130, 132, respectively, of the first conductive coating 106 are provided a first set of electrodes 110 and 112. Similarly, second conductive coating 108 is provided at opposite sides 134, 136 with a second set of electrodes 120 and 122 that are perpendicular with respect to the first set of electrodes 110 and 112. In another embodiment, the first and second sets of electrodes may be positioned at other angles with respect to each other. Each of the first and second conductive coatings 106 and 108 has an associated resistance measured between the electrodes of the respective conductive coating. For example, a resistance associated with the first conductive coating 106 may be measured between the first set of electrodes 110 and 112, and a resistance associated with the second conductive coating 108 may be measured between the second set of electrodes 120 and 122. In one embodiment, the resistances of the first and second conductive coatings 106 and 108 may be in the range of 400 to 600 ohms, depending on the aspect ratio. In another embodiment, different materials and/or different thicknesses of the same or different materials may be used to form the first and second conductive coatings 106 and 108 to achieve different resistance values.

To detect X coordinates associated with one or two touches, first and second voltages from voltage source 114 are applied to electrodes 110 and electrode 112, respectively, thus establishing a voltage gradient across first conductive coating 106 in a first direction 118. One of the voltages may be ground or ground potential. The voltage on first conductive coating 106 at the touch location on a touch sensing area 116 is transmitted to second conductive coating 108 and hence to electrodes 120 and 122. The controller 138 measures the X coordinate by measuring the voltage at either electrode 120 or 122. To detect Y coordinates associated with the one or two touches, third and fourth voltages from voltage source 114 are applied to electrode 120 and electrode 122, respectively, thus establishing a voltage gradient across second conductive coating 108 in a second direction 126. Again, one of the voltages may be ground potential. In addition, the first and second directions 118 and 126 may be formed perpendicular or at other angular positions with respect to each other. The voltage on second conductive coating 108 at the touch location on touch sensing area 124 is transmitted to the first conductive coating 106 and hence to electrodes 110 and 112. The controller 138 measures the Y coordinate by measuring the voltage at either electrode 110 or 112. The touch sensing areas 116 and 124 may be the same with respect to each other. In one embodiment, the voltage sources 114 and 128 may be the same voltage source and in another embodiment the voltage sources 114 and 128 may be different voltage sources. However, the coversheet 102 and the substrate 104 are electrically disconnected with respect to each other in the absence of a touch, and thus there is no hard-wired connection between the coversheet 102 and the substrate 104.

During operation, a controller 138 biases the first set of electrodes 110 and 112 in a first cycle and the second set of electrodes 120 and 122 in a second cycle. A touch causes the coversheet 102 to deflect and contact the substrate 104 thus making a localized electrical connection between the first and second conductive coatings 106 and 108. The controller 138 measures one voltage in one direction in the first cycle and another voltage is measured in the other direction in the second cycle. These two voltages are the raw touch (x,y) coordinate data. Various calibration and correction methods may be applied to identify the actual (X,Y) display location within the touch sensing areas 116 and 124. For example, corrections may be used to correct linear and/or non-linear distortions.

The resistance of the first conductive coating 106 of coversheet 102 and the resistance of the second conductive coating 108 of the substrate 104 do not change when there is no touch and when there is one touch. When two touches are present, however, the resistance of one or both of the first and second conductive coatings 106 and 108 decrease. For example, if two touches are currently deflecting the coversheet 102 to create electrical contact with the substrate 104 in two different touch locations simultaneously, a portion of the conductive coating of the non-biased sheet between the two touches is in parallel with the resistance of the conductive coating of the biased sheet. In other words, when two touches are present, the resistance of one or both of the first and second conductive coatings 106 and 108 of the coversheet 102 and substrate 104, respectively, decreases. Furthermore, as the distance between the two points increases, the resistance decreases.

When the resistance decreases, the current increases. The current flowing between electrodes 110 and 112 and the current flowing between electrodes 120 and 122 may be referred to as “bias currents”, as the currents are induced by a bias voltage to produce voltage gradients for coordinate measurements. In some embodiments, the bias currents change based on the axial separation or distance between the two simultaneous touches. Therefore, by either measuring the change in resistance or the change in bias current, the controller 138 can determine that two touches are present, can identify that the returned coordinates when two touches are present are of a point located on a line between two actual touch coordinates, and also can detect movement of one or both of the touches with respect to the other touch. At least some of the embodiments herein describe systems and methods for measuring the changes in bias currents.

To measure bias current, current sensing resistors 140 and 142 may be placed in series with the voltage detection circuits (i.e. within the controller 138) of each of the coversheet 102 and substrate 104, respectively). The resistors 140 and 142 have a relatively small value so as not to negatively impact the coordinate sensing capability of the controller 138, such as by increasing voltage offsets in the calibration correction. The resistors 140 and 142 may be provided within the controller 138. In one embodiment, the resistors 140 and 142 may each be a traction of the resistances of the associated first and second conductive coatings 106 and 108, such as approximately 10 percent.

During the first cycle, when the controller 138 biases the X direction by placing a voltage across the coversheet 102, the controller 138 may read a voltage drop across the resistor 140, such as at points A and B. The controller 138 may then calculate a bias current Iₓ based on the voltage drop. When no touch is present and when one touch is present, the bias current Iₓ is a reference value (as shown in FIG. 12). Similarly, during the second cycle the controller 138 biases the Y direction by placing a voltage across the substrate 104 and reads the voltage drop across the resistor 142 at points D and E. The controller 138 then calculates a bias current I_{Y} based on the voltage drop. The Y direction also has a reference value (as shown in FIG. 12) when no touch is present and when one touch is present.

Therefore, when calculating X and Y coordinate values, the controller 138 may also sense the bias current to determine whether the bias current has changed. An increase in one or both of the bias currents from the reference values may indicate that two touches are detected while a decrease in the bias current back to the reference values may indicate that a single touch or no touch has been detected.

In one embodiment, an A/D converter (not shown), such as within the controller 138, may be used to sense the voltage drop across the resistors 140 and 142. However, the voltage drop across the resistors 140 and 142 may be low compared to the operational range of the A/D converter. Therefore, amplification circuits 144 and 146 may be provided to amplify the voltage drop so that changes in the voltage drop may be more easily determined. The controller 138 may then read the amplified voltage levels at points C and F, for example.

As discussed previously, the position of the two touches with respect to each other impacts the level of bias current. The farther apart the two touches are, the greater the bias current because the resistance decreases as the two touches are moved farther apart. Therefore, if a user is touching the coversheet 102 at points indicated as first and second touches 148 and 150 and moves at least one of the touches 148 and 150 closer to the other, such as by pinching two fingers together, at least one of the X and Y bias currents decreases. Two finger gestures may thus be determined based on bias current values or changes in the bias current values.

FIG. 2 illustrates a circuit 320 representative of resistance within touchscreen system 322. The touchscreen system 322 may be the 4-wire touchscreen system 100 of FIG. 1. The touchscreen system 322 has a substrate 324 and coversheet 326. A set of electrodes 328 and 330 is mounted on the substrate 324. A conductive coating (not shown) is also applied to the facing sides of the substrate 324 and coversheet 326.

The controller (not shown) alternately pulses the X and Y directions as shown, using voltage source 332, and measures the bias current with current meter 334. When a user presses on the coversheet 326 at two different locations, first and second touches 336 and 338 result. The controller senses the change in bias current, such as through the current meter 334 or through current sensing resistors (not shown) or other current or voltage sensing methods and apparatus, and determines that two touches are present.

Turning to the circuit 320, the resistance of the substrate 324 is illustrated as R_{substrate} 340 and is connected on either side to voltage source 342 and current meter 344. Contact resistance between the substrate 324 and the coversheet 326 is illustrated as first and second variable R_{contact} 346 and 348. The resistance of the coversheet 326 between the first and second touches 336 and 338 is illustrated as R_{coversheet} 350. The length of R_{coversheet} 350 depends on the position of the first and second touches 336 and 338 relative to each other.

As contact resistances between the substrate 324 and coversheet 326 increase, such as by decreasing pressure, the resistances of both first and second conductive coatings 106 and 108 also increases. If the pressure of one or both of the first and second touches 336 and 338 varies, resulting in variations of one or both of the bias currents, erroneous detection of gestures may result. In one embodiment, if the conductive coating on the coversheet 326 is formed of a material that is not ITO but rather thin transparent metallic film, the contact resistance (the first and second variable R_{contact} 346 and 348) is very small. By reducing the contact resistance, the pressure of the first and second touches 336 and 338 has little or no effect on the detection of gestures.

In other embodiments, to prevent erroneous detection of gestures, the controller 138 may filter out rapid fluctuations in the bias currents that may be due to changes in contact resistance. In another embodiment, the controller 138 may respond based on an overall trend of the bias current, such as over a minimum time period or for the duration of the two finger touch. In yet another embodiment, at least one pressure sensor may be mounted on the substrate 324 to detect changes in an aggregate finger pressure (i.e. pressure at one or more touches). Returning to FIG. 1, a pressure sensor 154 is mounted on the substrate 104 and is monitored by the controller 138. The pressure sensor 154 may be, for example, formed to encompass a perimeter of the substrate 104, be configured to be mounted at each of the four corners of the substrate 104, be configured to be mounted at four central points on the substrate 104, or may be of any shape along the sides of the substrate 104. The controller 138 may thus filter fluctuations in the bias current based on the changes in pressure detected by the pressure sensor 154.

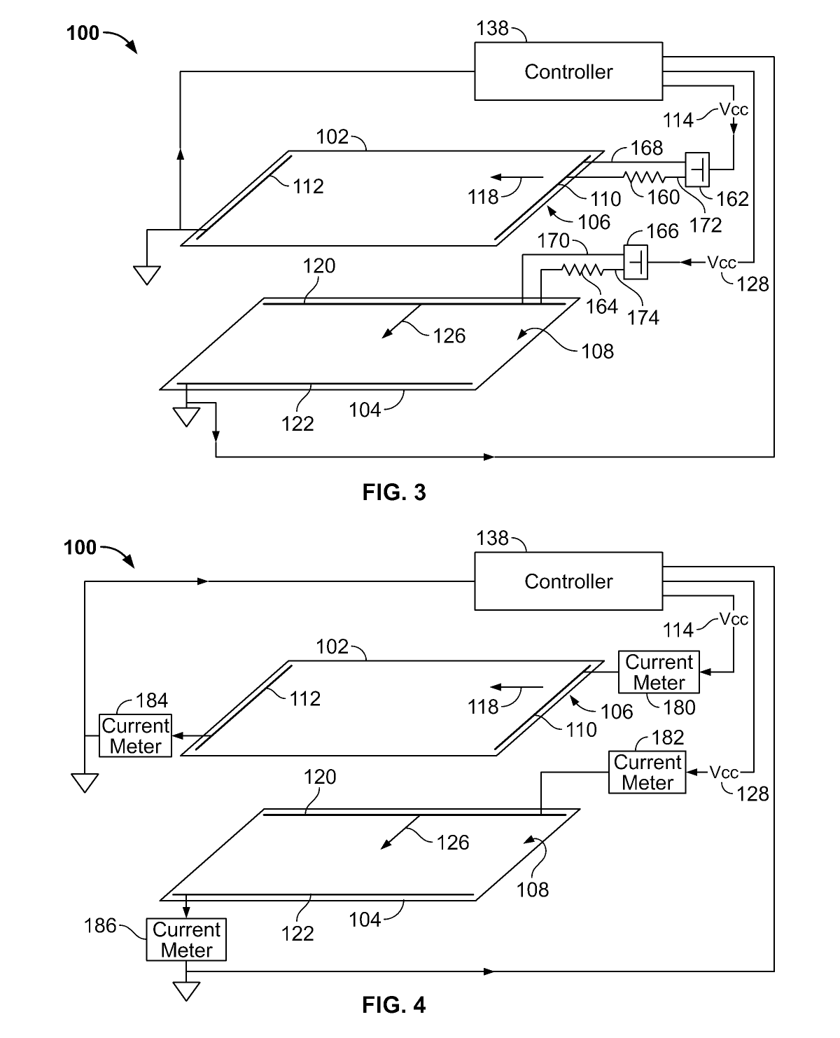

FIG. 3 illustrates the resistive touchscreen system 100 that senses the bias currents in a cycle separate from the coordinate detection cycles. As discussed above, the controller 138 alternately biases the coversheet 102 and the substrate 104 in separate cycles to detect the X and Y coordinates. In many resistive touchscreen systems 100, the controller 138 has a third cycle, sometimes referred to as a detect cycle, that may be used to verify that a touch is present. The third cycle may also be used as a power saving cycle, wherein the controller 138 remains in the third cycle until a touch is detected. When a touch is detected, the first and second detecting cycles are activated.

For the coversheet 102, a current sensing resistor 160 and a switch 162 are placed between the voltage source 114, which may be within the controller 138, and the coversheet 102. Also, a current sensing resistor 164 and a switch 166 are placed between the voltage source 128 and the substrate 104. It should be understood that the resistor and switch may together be positioned on the other side of the coversheet 102 and substrate 104, and/or may be within the controller 138.

To sense the X coordinate, the controller 138 connects the switch 162 to line 168 and to sense the Y coordinate, the controller 138 connects the switch 166 to line 170. During the third cycle, the controller 138 may alternately connect the switch 162 to line 172 and the switch 166 to line 174. Therefore, during one third cycle, the controller 138 may sense the voltage drop across the resistor 160 and in the next third cycle, the controller 138 may sense the voltage drop across the resistor 164. The controller 138 may determine the bias currents based on the voltage drops as discussed above.

Because the bias current is being sensed during a cycle other than when the X and Y coordinates are being sensed, the values of the resistors 160 and 164 may be larger than the values of the resistors 140 and 142 of FIG. 1. In one embodiment, the values of the resistors 160 and 164 may be approximately the same as the resistances of the associated first and second conductive coatings 106 and 108, respectively, when no touch is present. Having a larger resistance value may eliminate the possible need for an amplification circuit.

In another embodiment, one or more additional cycle(s) may be added to sense the bias currents. For example, the controller 138 may detect the X and Y coordinates in the first and second cycles, then detect the first and second bias currents in third and fourth cycles. Therefore, a detection frame may have 4 or 5 total cycles. In yet another embodiment, once two touches are detected, the controller 138 may no longer detect the X and Y coordinates and may only detect the first and second bias currents.

FIG. 4 illustrates the resistive touchscreen system 100 that senses the bias currents using one or more current meters. Here, “current meter” generally means any electronic method for measuring current. Current meters 180 and 182 may be implemented in an application-specific integrated circuit (ASIC). Current meter circuits may be separate entities or combined with circuits of voltage sources 114 and 128, respectively. The placement of the current meters 180 and 182 may be moved within the circuits (such as shown with current meters 184 and 186) and the current meters 180 and 182 may be within the controller 138. The current meters 180 and 182 may detect the bias currents during the same cycle as the controller 138 uses to detect the X and Y coordinates, or alternatively during the third cycle or during third and fourth cycles as discussed above with FIG. 3.

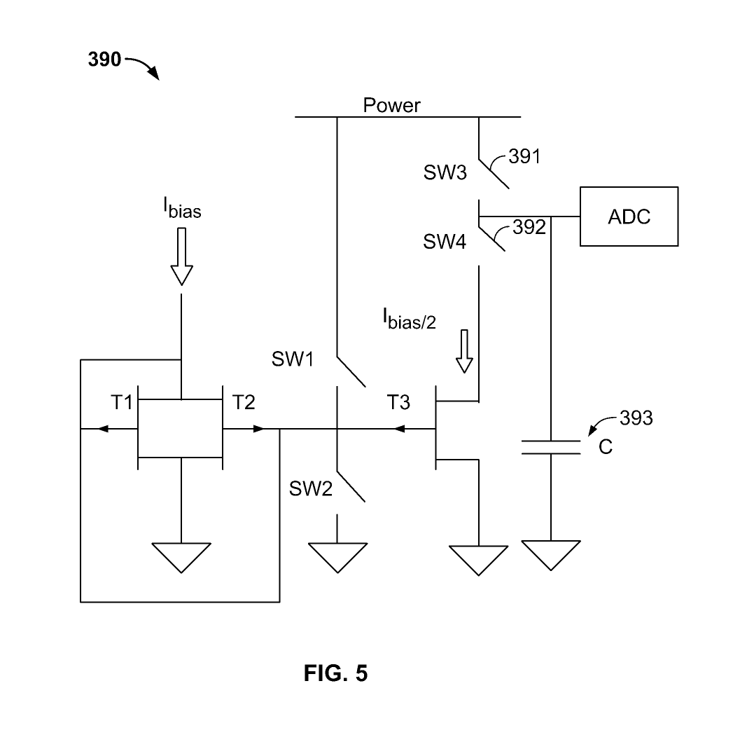

FIG. 5 illustrates a conceptual circuit diagram of a current measuring circuit 390 as may be implemented on an ASIC. For example, current measurement may be accomplished with a current mirror circuit using switched capacitor load. On silicon, transistors and capacitors are relatively easy to fabricate, while resistors are more difficult to fabricate accurately. Switch SW3 391 and switch SW4 392 may be rapidly cycled through the sequence of: SW3 closed, SW3 opened, SW4 closed and SW4 opened over a period of time T. Therefore, for sufficiently last switching frequency f=1/T, switches SW3 and SW4 391 and 392 and capacitor C 393 approximate a resistor of resistance T/C.

In yet another embodiment, a virtual ground may be used as a current sink without losing the ability to measure current. All current through the coversheet 102 and substrate 104 (as shown in FIG. 1) passes through a virtual ground at a negative input of a high-gain amplifier and passes through a feedback resistor. The digitized voltage across the feedback resistor provides a measure of the bias current.

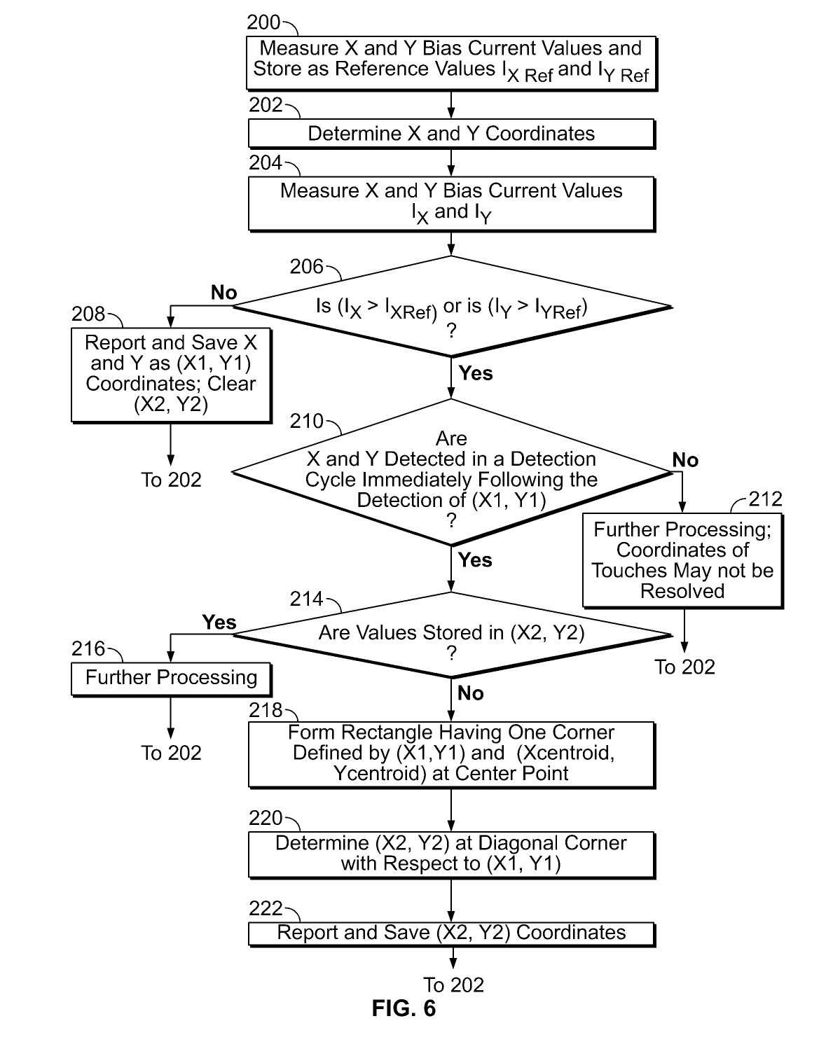

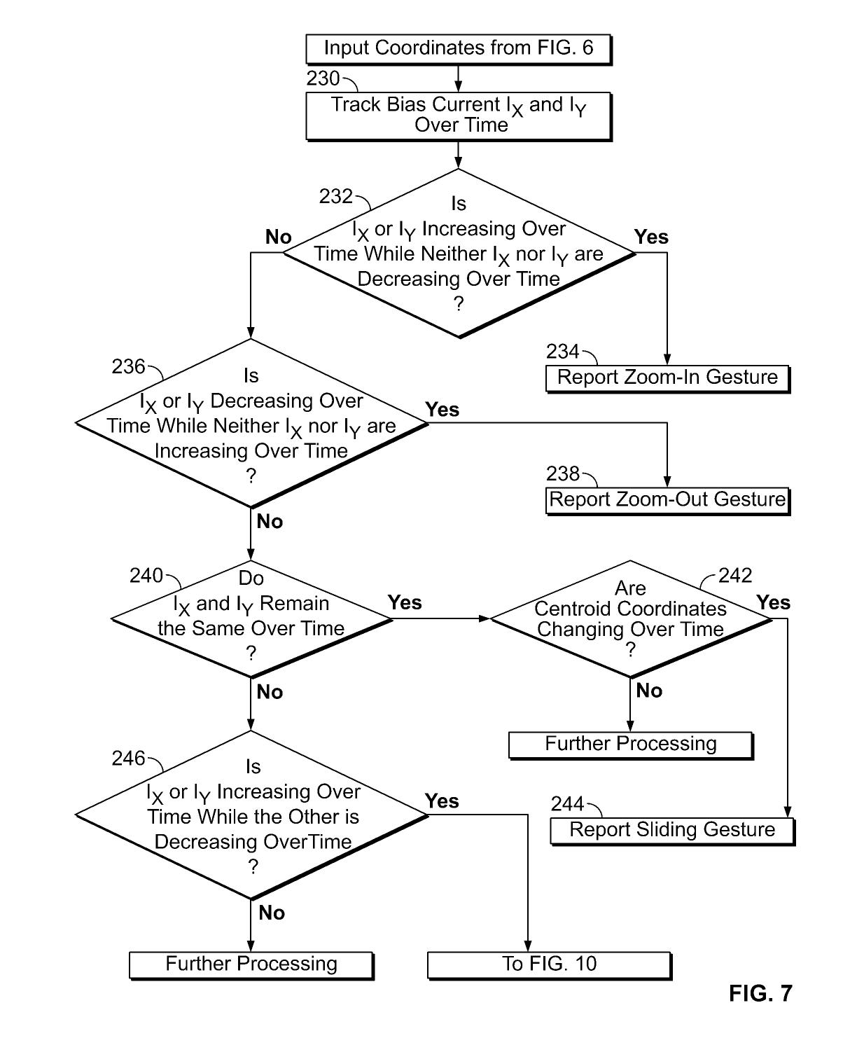

FIG. 6 illustrates a method for determining if two touches are present and for identifying the initial coordinates of the two touches. At 200, the controller 138 may measure the X and Y bias current values and store the X and Y bias current values as reference values I_{X Ref} and I_{Y Ref}. This may be accomplished at start-up of the touchscreen system 100, for example when no touch is present, or the reference values I_{X Ref} and I_{Y Ref} may be predetermined and stored within the controller 138.

At 202, the controller 138 determines the X and Y coordinates, and at 204 the controller 138 measures the X arid Y bias currents Iₓ and I_{y} as discussed above. Therefore, 202 and 204 may be accomplished during the same or different cycles. At 206 the controller 138 compares the bias currents Iₓ and I_{y} to the reference values I_{X Ref} and I_{Y Ref}, respectively. If neither of the bias currents Iₓ and I_{y} is greater than the respective reference value I_{X Ref} and I_{Y Ref}, a single touch or no touch has been detected and the method passes to 208. The controller 138 may then report the X and Y coordinates to the operating system (not shown) of the touchscreen system 100. The controller 138 may also save the X and Y coordinates as a first coordinate (X1,Y1). However, if no coordinates were detected, then no coordinates are reported or stored and the first coordinate (X1,Y1) may be cleared. If the single set of X and Y coordinates is detected, the controller 138 may clear or zero the contents of a second coordinate (X2,Y2). The second coordinate (X2,Y2) may have been generated during a previous detection of two simultaneous touches but is no longer valid. The second coordinate (X2,Y2) is further discussed below.

Returning to 206, if either of the bias currents Iₓ and I_{y} is greater than the respective reference value I_{X Ref} and I_{Y Ref}, two touches have been detected. It should be noted that if both of the touches are anywhere along a voltage line of equipotential in one of the X and Y directions, the bias current will not increase in that direction. At 210 the controller 138 determines whether the currently detected X and Y coordinates were detected in a detection cycle immediately following the detection of (X1,Y1). A lapse in time has occurred if the currently detected X and Y coordinates are not detected immediately after (X1,Y1), indicating that the previously stored coordinate (X1,Y1) may not correlate to a current touch. Therefore, the touchscreen system 100 has detected two new touches within the same detection cycle and the method passes to 212. Because there are two touches, the currently detected X and Y coordinates are of a point (X,Y) located along a line between the actual touches. At 212 further processing may be accomplished to attempt to determine the actual locations of the two touches, however, in some embodiments the coordinates of the two touches may not be resolved. In one embodiment, the controller 138 may use the coordinates of the point (X,Y) in applications as discussed below that may not require the identification of the particular coordinates. In other embodiments, an error may be generated or the controller 138 may ignore the input, returning to 202 to continue to detect X and Y coordinates.

Returning to 210, if the controller 138 determines that the currently detected X and Y coordinates (X,Y) were detected in a detection cycle immediately following the detection of (X1,Y1), indicating that (X1,Y1) is still a valid coordinate, the method passes to 214 where the controller 138 may determine if values are stored in (X2,Y2). If yes, in 216 further processing, such as gesture recognition as discussed below in FIG. 7, may be used. If there are no values stored in (X2,Y2), the controller 138 may determine the second coordinate (X2,Y2) based on the first coordinate (X1,Y1) and the coordinates of the point (X,Y). If contact resistance effects can be ignored, the point (X,Y) may be considered to be centroid coordinates (X_{centroid},Y_{centroid}) located approximately half-way between (X1,Y1) and (X2,Y2). However, if contact resistance effects cannot be ignored, the controller 138 may wait a period of time, or a number of detection cycles, for transient contact-resistance effects to dissipate prior to defining the point (X,Y) as centroid coordinates (X_{centroid},Y_{centroid}). At 218 the controller 138 may form a rectangle having one corner defined by (X1,Y1) and (X_{centroid},Y_{centroid}) at a center point of the rectangle. At 220 the controller 138 may determine (X2,Y2) to be located at a diagonal corner of the rectangle with respect to (X1,Y1) wherein a straight line connecting (X1,Y1) and (X2,Y2) passes through (X_{centroid},Y_{centroid}). At 222, the controller 138 may report and save the second coordinate (X2,Y2). Alternatively, at 218 the controller 138 may extend a line a distance between the first coordinate (X1,Y1) and the centroid coordinate (X_{centroid},Y_{centroid}). The line may then be extended an equal distance, forming a straight line that ends at the second coordinate (X2,Y2). It should be understood that other methods may be used to determine the second coordinate (X2,Y2).

FIGS. 7 and 10 illustrate a method for identifying gestures that use two touches. Changes in the two touches relative to each other are determined based on changes in the bias currents. Inputs to FIGS. 7 and 10 may be the first and second coordinates (X1,Y1) and (X2,Y2), however some embodiments may use the centroid coordinates (X_{centroid},Y_{centroid}) in addition to or instead of one or both of the initial coordinates. For example, referring to 216 and 222 of FIG. 6, the controller 138 has determined the first and second coordinates (X1,Y1) and (X2,Y2) as the initial coordinates. Inputs to FIGS. 7 and 10 may also be the centroid coordinates (X_{centroid}, Y_{centroid}), such as were determined at 212.

The gestures discussed in FIGS. 7 and 10 are exemplary responses to the detected change(s) in bias currents that result from the movement of the two touches with respect to each other. It should be understood that other gestures may be paired with a particular moving relationship between the two touches. Furthermore, the gestures may be application dependent or application independent. Therefore, the operating system may initiate one response to a gesture when running a first application and a different second response to the same gesture when running a second application. Multiple windows for multiple applications may be displayed simultaneously on the touchscreen system 100, therefore, using the same gesture in the two different windows may result in different responses or the same response from the operating system.

Turning to FIG. 7, at 230, the controller 138 tracks the bias currents Iₓ and I_{y} over time to determine whether one or both of the touches are moving. The controller 138 may utilize a minimum time period or other detection algorithms to ensure that the gesture is indicated by the user and that the change in bias current is not due to a slight touch pressure difference or change over time (such as when the user is initially contacting the coversheet 102) at one or both of the touches. For example, a minimum time period may be several milliseconds, which may be sufficient to determine the intent of the gesture based on the application. In another embodiment, the controller 138 may track the bias currents over time until at least one of the touches is lifted before identifying the gesture.

At 232, the controller 138 determines whether at least one of the bias currents Iₓ and I_{y} is increasing over time while neither is decreasing over time. If yes, this indicates that the two touches are moving away from each other and the method passes to 234. The controller 138 may report a zoom-in gesture to the operating system. In response the operating system may perform a zoom-in operation based on information, characters, pictures and the like that are currently displayed beneath the touchscreen system 100 corresponding to the centroid coordinates (X_{centroid},Y_{centroid}) and/or the first and second coordinates (X1,Y1) and (X2,Y2). As discussed previously, the gesture associated with the increasing bias current(s) may be a gesture other than zoom-in. Also, the application associated with the information on the touchscreen that correlates to the coordinates may determine the gesture response.

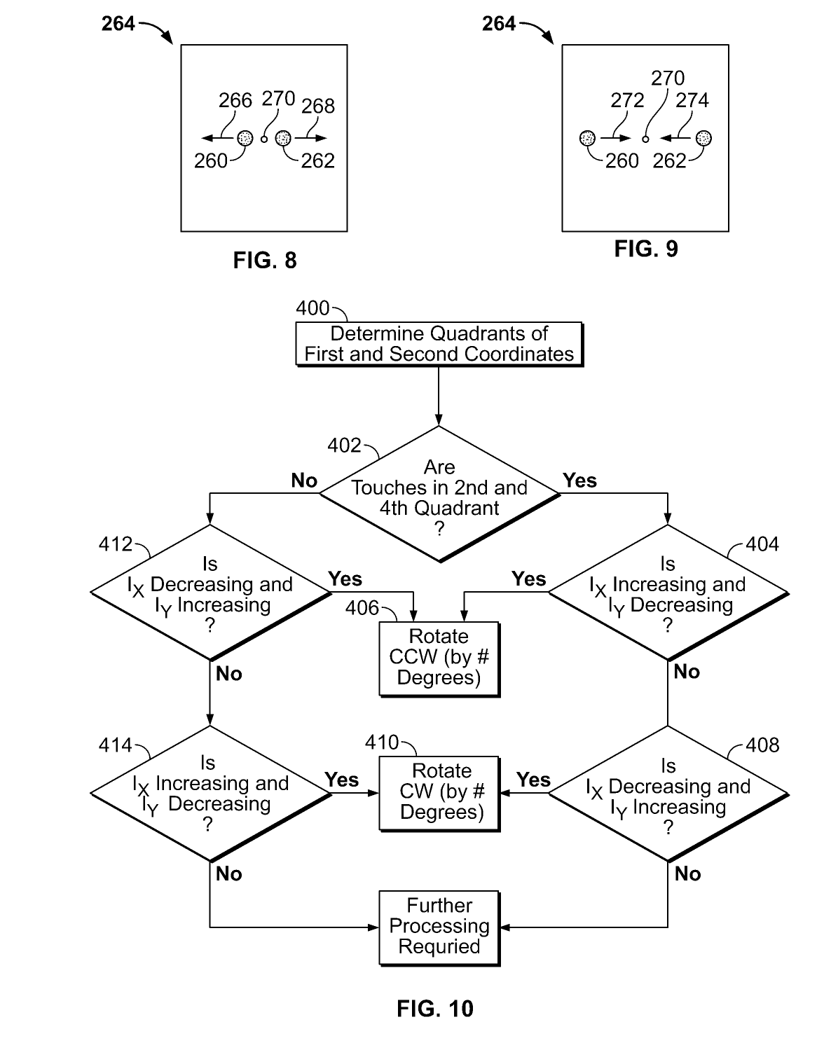

FIG. 8 illustrates first and second touches 260 and 262 on a resistive touchscreen 264 that are moving away from each other as indicated by arrows 266 and 268. The user may use this gesture to zoom-in on the data, image and/or other information that is displayed corresponding to centroid coordinates 270 and/or the coordinates corresponding to the first and second touches 260 and 262. The operating system may then zoom-in by a predetermined amount or percentage. The amount of zoom may be determined by the application associated with the information, or may be preset by the user. It should be understood that a touchscreen system 100 may associate a different gesture than zoom-in when the first and second touches 260 and 262 are moved away from each other. In addition, different applications may assign different responses to the same gesture.

Returning to FIG. 7, if one or both of the touches is not moving away from the other, the method passes from 232 to 236 where the controller 138 determines whether at least one of the bias currents Iₓ and I_{y} is decreasing over time while neither is increasing over time. If yes, this indicates that the two touches are moving closer with respect to each other and the method passes to 238. At 238, the controller 138 may report a zoom-out gesture to the operating system. By way of example only, zoom-in and zoom-out may be used in applications for virtual volume control, sizing of photos and maps, and the like.

FIG. 9 illustrates the first and second touches 260 and 262 on the resistive touchscreen 264 that are moving towards each other as indicated by arrows 272 and 274. The user may use this gesture to request a zoom-out on the information that is displayed with respect to the centroid coordinates 270 and/or the coordinates corresponding to the first and second touches 260 and 262.

Returning to FIG. 7, if one or both of the first and second touches 260 and 262 is not moving towards the other, the method passes from 236 to 240 where the controller 138 determines whether the bias currents Iₓ and I_{y} remain unchanged over time. There may be a predetermined range or percentage of bias current change wherein the controller 138 determines that no change has been indicated by the user. If yes, the method passes to 242 where the controller 138 determines whether the apparent touch coordinates, which may be the point (X,Y) or the centroid coordinates (X_{centroid},Y_{centroid}), for example, are changing over time. If yes, at 244 the controller 138 may report a sliding gesture to the operating system. The controller 138 may also report the change in coordinates and/or the new coordinate locations. For example, the sliding gesture may be used to move an item or window on the touchscreen.

If the response at 240 is no, the method passes to 246 where the controller 138 determines whether one of the bias currents Iₓ and I_{y} is increasing over time while the other is decreasing over time. If yes, the gesture may be a rotate gesture and the method passes to FIG. 10.

Due to the sinusoidal nature of the changes in the X and Y separation distances when making the rotate gesture, opposing changes in the bias currents can occur even when the distance between the two touches remains the same. Therefore, during a rotation the controller 138 may detect an increase in the bias current Iₓ and a decrease in the bias current I_{y}. As the rotation continues, or during a different rotation, the controller 138 may detect an increase in the bias current I_{y} and a decrease in the bias current Iₓ. The change in bias current may be within a predetermined percentage or range, or may be tracked over a predetermined period of time to determine that the rotate gesture is being indicated. If yes, this indicates that the two touches are rotating with respect to each other.

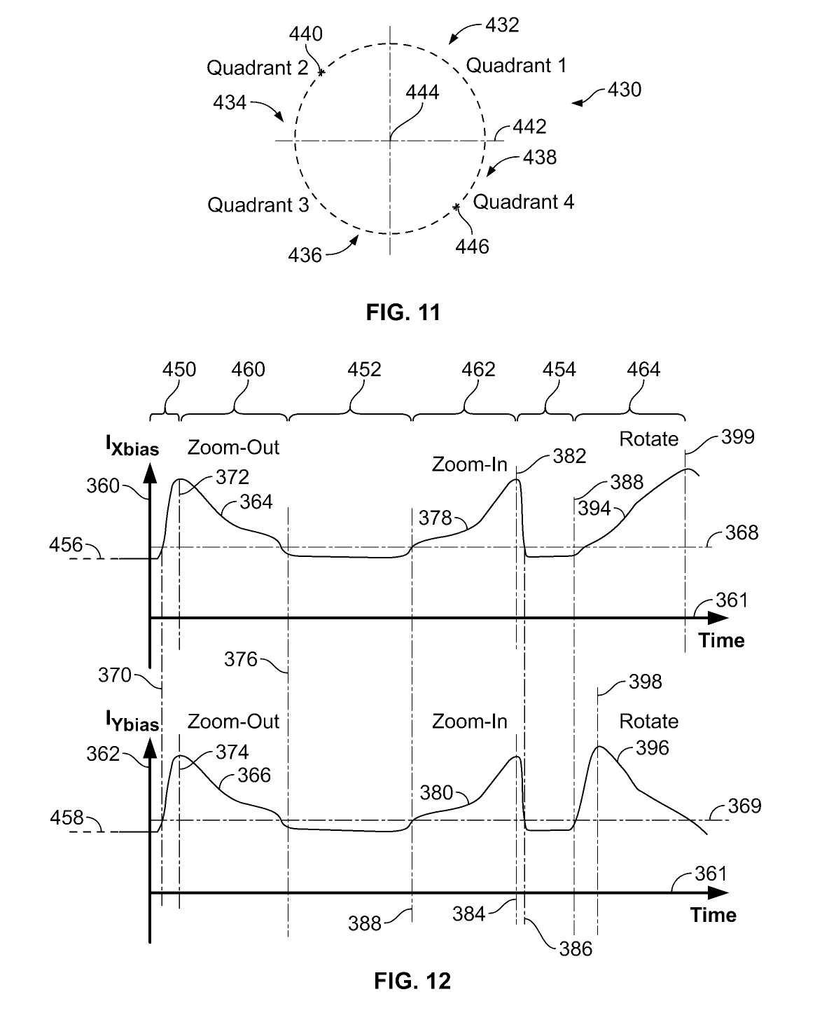

Some ambiguity exists for determining whether the rotation is in the clockwise (CW) or counter-clockwise (CCW) direction. FIG. 11 illustrates a set of quadrants 430, indicated as first quadrant 432, second quadrant 434, third quadrant 436, and fourth quadrant 438. X-Y axis 442 may be defined relative to the X and Y directions of the touchscreen system 100.

Turning to FIG. 10, at 400 the controller 138 determines what quadrants the first and second coordinates (X1,Y1) and (X2,Y2) are in. For example, in FIG. 11, a center point 444 of the X-Y axis 442 may be defined based on the centroid coordinates (X_{centroid},Y_{centroid}). A first touch 440 (the first coordinate (X1,Y1)) is identified in the second quadrant 434 and a second touch 446 (the second coordinate (X2,Y2)) is identified in the fourth quadrant 438.

At 402, the controller 138 determines whether the first and second touches 440 and 446 are in the second and fourth quadrants 434 and 438. If yes, the method passes to 404, where the controller 138 determines whether the bias current Iₓ is increasing and the bias current I_{y} is decreasing. If yes, the method passes to 406 where a CCW rotate gesture is reported to the operating system. The amount of rotation may be dependent on the application. For example, if the application is displaying photos, the amount of rotation may be 90 degrees in the selected direction. Other applications may use smaller or larger amounts of rotation.

Returning to 404, if the response is no, the method passes to 408 where the controller 138 determines whether the bias current Iₓ is decreasing and the bias current I_{y} is increasing. If yes, the method passes to 410 where a CW rotate gesture is reported to the operating system.

Returning to 402, if the first and second touches 440 and 446 are in the first and third quadrants 432 and 436, the method passes to 412 where the controller 138 determines whether the bias current Iₓ is decreasing and the bias current I_{y} is increasing. If yes, the method passes to 406 and a CCW rotate gesture is reported to the operating system. At 414, the controller 138 determines if the bias current Iₓ is increasing and the bias current I_{y} is decreasing. If yes, the method passes to 410 and a CW rotate gesture is reported to the operating system.

FIG. 12 illustrates example signal profiles or traces corresponding to bias currents associated with zoom-out, zoom-in and rotate gestures. Some variation in pressure at one or both of the touches may be acceptable and/or filtered based on predetermined parameters. X and Y bias currents 360 and 362 are shown over time 361. The controller 138 may detect the two finger state, for example, when at least one of the X and Y bias currents 360 and 362 exceeds a respective bias current threshold level 368 and 369. The bias current threshold levels 368 and 369 may be the same or different with respect to each other. For example, during time durations 450, 452 and 454 between the three gestures there is either only a single touch or no touch at all. In either case, the bias currents return to the values corresponding to a zero-touch or single touch states, referred to as reference values 456 and 458.

Zoom-out signal traces 364 and 366 are indicated during time duration 460. The controller 138 may detect a start time 370 of the two-finger state, a time of a signal maximum 372 and 374 for each of the signal traces 364 and 366, and an end time 376 of the two-finger state when at least one of the bias currents returns to below the threshold levels 368 and 369. Therefore, for the zoom-out signal traces 364 and 366, a signature of signal timing is that the time difference between each of the signal maximums 372 and 374 and the start time 370 is less than the time difference between the signal maximums 372 and 374 and the end time 376. For zoom-in signal traces 378 and 380 indicated during tune duration 462, signal maximums 382 and 384 are closer to end time 386 than start time 388. For rotate signal traces 394 and 396 indicated during time duration 464, one signal maximum 398 is closer to start time 388 while the other signal maximum 399 is closer to the end time (not shown).

The controller 138 may determine the gesture based on signal profiles of the X and Y signal traces. For example, the controller 138 may detect the start and end times of the two-finger state. The controller 138 may then compare the X and Y signal traces to predetermined profiles that represent different gestures. Alternatively, the controller 138 may analyze the X and Y signal traces, such as to determine a time relationship between the signal maximum and each of the start and end times.

The dual touch sensing and gesture recognition discussed herein is applicable to resistive touchscreens other than 4-wire. In each of the configurations of 3-, 4-, 5-, 7-, 8-, and 9-wire touchscreens, the bias currents I_{X} and I_{Y} through the drive lines increase when two touches are simultaneously present. The 4-wire touchscreen of FIG. 1 may be converted into an 8-wire touchscreen by adding an extra wire connection between controller 138 and each of electrodes 110, 112, 120 and 122. The 8-wire design provides separate drive and sense lines to each electrode so that when a voltage is delivered to an electrode through a current-carrying drive line, the actual voltage at the electrode can be sensed through a line not carrying current and hence not subject to an Ohmic voltage drop.

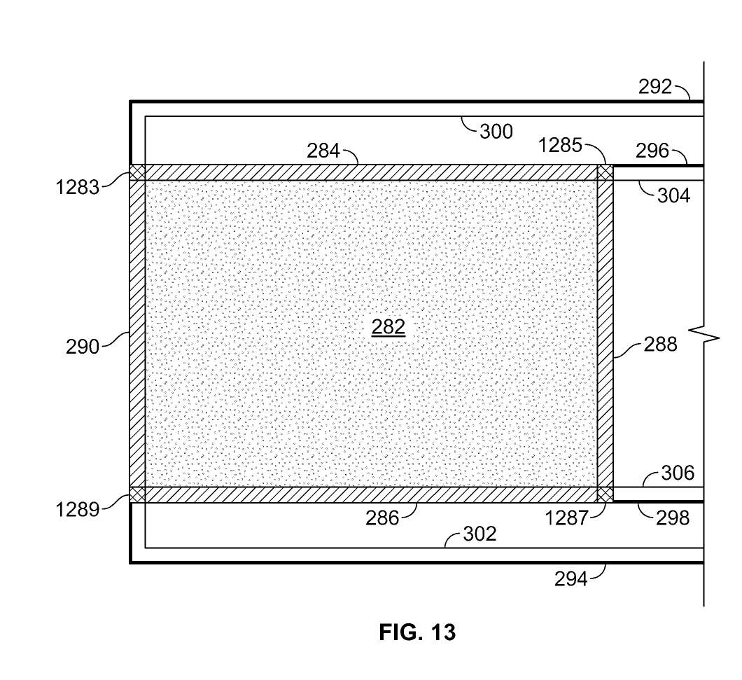

FIG. 13 schematically illustrates in plane view a resistive touchscreen substrate 282 with a conductive coating on its surface, electrode structures 284, 286, 288 and 290 on the four sides of the substrate 282, and electrical interconnection points 1283, 1285, 1287 and 1289 at the four corners. Not shown is a coversheet placed over the substrate 282. In one embodiment, the materials forming the conductive coatings may be selected so that the resistance of the conductive coating of the coversheet is less than the resistance of the conductive coating of the substrate 282. By reducing the resistance of the parallel current path through the coversheet, the magnitude of the bias current change due to a multiple touch condition is increased.

The coversheet is provided with one wire (not shown) for connection to voltage sensing circuitry of a controller (not shown). In a 5-wire touchscreen, in addition to the wire to the coversheet, four wires 292, 296, 298 and 294 connect the controller to corner electrical interconnection points 1283, 1285, 1297 and 1289 respectively. In a 9-wire touchscreen, wires 300, 304, 306 and 302 also connect the controller to corner interconnection points 1283, 1285, 1287 and 1289, respectively, so as to provide separate drive and sense lines to each corner. However, these extra four wires are not present in the 5-wire touchscreen. During X coordinate measurement, a bias voltage is applied between the pair of right corner interconnection points 1285 and 1287 and the pair of left corner interconnection points 1283 and 1289. A voltage, for example 3.3 Volts, applied to the right pair of corner interconnection points 1285 and 1287 is transmitted via electrode structure 288 to the right side of the conductive coating. Similarly, a voltage, say 0 Volts, applied to the left pair of corner interconnection points 1283 and 1289 is transmitted via electrode structure 190 to the left side of the conductive coating. Such an X bias voltage (difference) between the right and left sides induces a voltage gradient in the conductive coating. Associated with this X bias voltage is a corresponding X bias current I_{X} and hence, via Ohm's Law, an X bias load resistance. Similarly when a Y coordinate is being measured there is an Y bias voltage applied between the pair of corner interconnection points 1283 and 1285 and the pair of corner interconnection points 1287 and 1289, resulting in Y bias current I_{Y} and corresponding Y bias load resistance.

The 3-wire touchscreen is similar to the 5-wire touchscreen. In a 3-wire touchscreen, one wire connects to the coversheet and only two wires connect to the substrate 282 shown in FIG. 13. For example, wire 292 to corner interconnection 1283 and wire 298 to diagonally opposite corner interconnection point 1287 may be present while wires 294 and 296 as well as wires 300, 302, 304 and 306 are absent. In the 3-wire design electrode structures 284, 286, 288 and 290 contain diode arrays so that, for example, if wire 298 is powered at a positive voltage and wire 292 is grounded, current flows only through electrode structures 288 and 290 thus establishing a voltage gradient in the X direction. Associated with such an X bias voltage is the X bias current I_{X} as well as the X bias load resistance. In contrast, if wire 292 (instead of wire 298) is powered and wire 298 is grounded, current flows only through the top and bottom electrode structures 284 and 286 thus establishing a Y voltage gradient for Y coordinate measurement. Associated with such a Y bias voltage is a Y bias load resistance and the Y bias current I_{Y}.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third.” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

What is claimed is:

1. A resistive touchscreen system, comprising:
a substrate comprising a first conductive coating having a first resistance;
a coversheet comprising a second conductive coating having a second resistance, the substrate and the coversheet positioned proximate each other such that the first conductive coating faces the second conductive coating, the substrate and coversheet being electrically disconnected with respect to each other in the absence of a touch;
a first set of electrodes formed on the substrate for establishing voltage gradients in a first direction;
a second set of electrodes formed on the coversheet for establishing voltage gradients in a second direction, the first and second directions being different; and
a controller configured to bias the first and second sets of electrodes in two different cycles, the controller further configured to sense a bias current associated with at least one of the first resistance and the second resistance, the bias current having a reference value associated with no touch, an increase in the bias current relative to the reference value indicating two simultaneous touches.

2. The resistive touchscreen system of claim 1, the bias current further comprising first and second bias currents, the system further comprising a first resistor positioned in series with one electrode in the first set of electrodes and a second resistor positioned in series with one electrode in the second set of electrodes, the controller further sensing the first and second bias currents based on voltage drops across the first and second resistors.

3. The resistive touchscreen system of claim 1, further comprising a first resistor positioned in series with one electrode in the first set of electrodes and a second resistor positioned in series with one electrode in the second set of electrodes, the controller further sensing the bias current based on voltage drops across the first and second resistors, the first and second resistors having values that are based on the first and second resistances.

4. The resistive touchscreen system of claim 1, the bias current further comprising a first bias current in the first direction further associated with the first resistance and a second bias current in the second direction further associated with the second resistance, the controller further configured to sense the first and second bias currents over time, the controller determining that the two simultaneous touches are moving relative to each other based on changes in the first and second bias currents.

5. The resistive touchscreen system of claim 1, further comprising first and second resistors, wherein the first resistor is connected on a first side to an electrode in the first set of electrodes that detects the voltage and on a second side to ground potential, wherein the second resistor is connected on a first side to an electrode in the second set of electrodes that detects the voltage and on a second side to the ground potential, the controller further sensing the bias current based on a voltage drop across the first and second resistors.

6. The resistive touchscreen system of claim 1, farther comprising:
first and second resistors, wherein the first resistor is connected on a first side to an electrode in the first set of electrodes that detects the voltage and on a second side to ground potential, wherein the second resistor is connected on a first side to an electrode in the second set of electrodes that detects the voltage and on a second side to the ground potential;
a first amplifier circuit in communication with the first resistor; and
and a second amplifier circuit in communication with the second resistor, the controller further sensing the bias current based on amplified signals measured across the first and second resistors.

7. The resistive touchscreen system of claim 1, wherein the bias current increases with an increase in axial separation between the two simultaneous touches.

8. The resistive touchscreen system of claim 1, wherein the conductive coatings comprise one of indium tin oxide (ITO), transparent metal film, carbon nanotube containing film, conductive polymer, and a conductive material, and wherein the first and second conductive coatings may be the same or different with respect to each other.

9. The resistive touchscreen system of claim 1, further comprising a pressure sensor mounted proximate to the substrate, wherein the pressure sensor is configured to detect changes in pressure associated with the one touch and the two simultaneous touches, wherein the controller is further configured to filter fluctuations in the bias current based on the changes in pressure.

10. A method for detecting two simultaneous touches on a resistive touchscreen system, comprising:
biasing a resistive touchscreen to generate voltage gradients along a first direction and a second direction;
detecting a first bias current associated with the first direction, the first bias current associated with a non-zero first reference value that is representative of a bias current along the first direction when no touch is present on the resistive touchscreen;
detecting a second bias current associated with the second direction, the second bias current associated with a non-zero second reference value that is representative of a bias current along the second direction when no touch is present on the resistive touchscreen; and
determining that two simultaneous touches are present on the resistive touchscreen when one of the first and second bias currents is greater than the first and second reference values, respectively.

11. The method of claim 10, further comprising:
comparing consecutively detected first bias currents to determine a change in the first bias current over time; and
comparing consecutively detected second bias currents to determine a change in the second bias current over time, wherein the changes in one of the first and second bias currents are used to determine movement of the two simultaneous touches relative to each other.

12. The method of claim 10, further comprising:
comparing consecutively detected first bias currents to determine a change in the first bias current over time;
comparing consecutively detected second bias currents to determine a change in the second bias current over time; and
identifying a zoom-in gesture when at least one of the first and second bias currents is increasing over time and neither of the first and second bias currents is decreasing over time.

13. The method of claim 10, further comprising:
comparing consecutively detected first bias currents to determine a change in the first bias current over time;
comparing consecutively detected second bias currents to determine a change in the second bias current over time; and
identifying a zoom-out gesture when at least one of the first and second bias currents is decreasing over time and neither of the first and second bias currents are increasing over time.

14. The method of claim 10, further comprising:
comparing consecutively detected first bias currents to determine a change in the first bias current over time;
comparing consecutively detected second bias currents to determine a change in the second bias current over time; and
identifying a rotate gesture when one of the first and second bias currents is increasing over time and the other is decreasing over time.

15. The method of claim 10, further comprising:
determining coordinate values of an initial touch, wherein the first bias current is equal to the first reference value and the second bias current is equal to the second reference value; and
determining coordinate values of a subsequent touch when at least one of the first and second bias currents is greater than the first and second reference values, respectively, the subsequent touch being detected in a detection cycle immediately following a detection cycle wherein the initial touch is present, wherein actual coordinate values of the subsequent touch are based on the coordinate values of the initial touch and the coordinate values of the subsequent touch.

16. The method of claim 10, wherein the first and second bias currents are detected during first and second consecutive cycles.

17. The method of claim 10, further comprising detecting first and second coordinates of the two simultaneous touches during two of three consecutive cycles, the first and second bias currents being alternately detected during a third cycle of the three consecutive cycles.

18. The method of claim 10, further comprising:
detecting a first coordinate associated with one touch on the resistive touchscreen or the two simultaneous touches on the resistive touchscreen during a first cycle;
detecting a second coordinate associated with the one touch or the two simultaneous touches during a second cycle;
detecting the first bias current during a third cycle; and
detecting the second bias current during a fourth cycle, wherein the first, second, third and fourth cycles are consecutive.

19. The method of claim 10, wherein when the two simultaneous touches are present on the resistive touchscreen, the method further comprising detecting the first and second bias currents without detecting first and second coordinates associated with the two simultaneous touches.

20. The method of claim 10, wherein a type of gesture is determined based on signal profiles of the first and second bias currents detected over time.
